(19) United States
(12) Patent Application Publication
(10) Pub. No.: US 2004/0063357 A1
(43) Pub. Date: Apr. 1, 2004

(54) Power plug housing

(75) Inventors: William M. Byrne, Atlus, AR (US); David M. Burns, Van Buren, AR (US)

Correspondence Address: WOOD, PHILLIPS, KATZ, CLARK & MORTIMER, 500 W. MADISON STREET, SUITE 3800, CHICAGO, IL, 60661, US

(73) Assignee: Baldor Electric Company

(21) Appl. No.: 10/261,820

(22) Filed: Oct. 1, 2002

(51) Int. Cl. H01R 25/00

(52) U.S. Cl. 439/638

(57) ABSTRACT

A two piece power plug housing for an electric machine has base and cover members hinged together forming an enclosure for the machine leads and male terminals. The leads and terminals are held in position in recesses in the housing and may be repositioned by opening the housing. Neck elements on the base and cover form a cylindrical neck inserted in the hole of the machine band to mount the housing.

### BACKGROUND OF THE INVENTION

An electrical machine, as a motor or generator has windings with multiple electric leads which are to be connected with conductors to a power source or load. It is known to terminate the electrical leads of the machine in a power plug, typically with a male terminal for each lead. The connection to a power source or load is made by coupling the plug with a complementary receptacle having female terminals which are connected through the conductors with the power source in the case of a motor or with a load in the case of a generator.

### BRIEF SUMMARY OF THE INVENTION

It is desirable that the power plug have a housing that permits physical repositioning of the machine leads as, for example, to configure a motor for operation at the appropriate voltage.

Another desirable feature of the power plug housing is that it be readily connectable with and separable from the machine to permit repositioning of the machine leads.

It is also desirable that the power plug housing be so connected with the enclosing band of the machine that the danger of water or dirt entering the machine is minimized.

In accordance with these desirable characteristics, it is one feature of the power plug housing that it comprise a base member with a receiver for the electric leads of the machine and a cover member with a retainer which holds the leads in the receiver of the base member.

Another feature of the power plug housing is that it has two complementary members engaged to form the housing which receives and encloses the electric leads of the electric machine and terminals at the ends of the leads, the housing members each having an inner end wall for engagement with the band of the machine and complementary semi-cylindrical neck elements on the inner end walls of both housing members forming a cylindrical neck with the members engaged. The cylindrical neck is insertable into an opening in the machine band, with the electric leads extending through the cylindrical neck into the plug housing. Retaining ridges on the outside of the neck elements engage the machine band to fasten the housing thereto.

A further feature of the power plug housing is that a fastener, as the cylindrical neck, is insertable into an opening in the machine band and forms a joint with the band. A fin extends across the joint to minimize the entry of water or dirt.

Further features and advantages of the power plug housing with be apparent from the following specification and from the drawings.

### BRIEF DESCRIPTION OF THE SEVERAL VIEWS OF THE DRAWING

FIG. 1 is an end view of the band of an electrical machine showing multiple electric leads, the power plug housing and a mating receptacle;

FIG. 2 is a side view of the band, power plug housing and receptacle from above FIG. 1, with a portion of the band broken away;

FIG. 3 is a sectional view taken along line 3-3 of FIG. 1;

FIG. 4 is a sectional view taken along line 4-4 of FIG. 2;

FIG. 5 is a perspective of the power plug cover; and

FIG. 6 is a perspective of the power plug base.

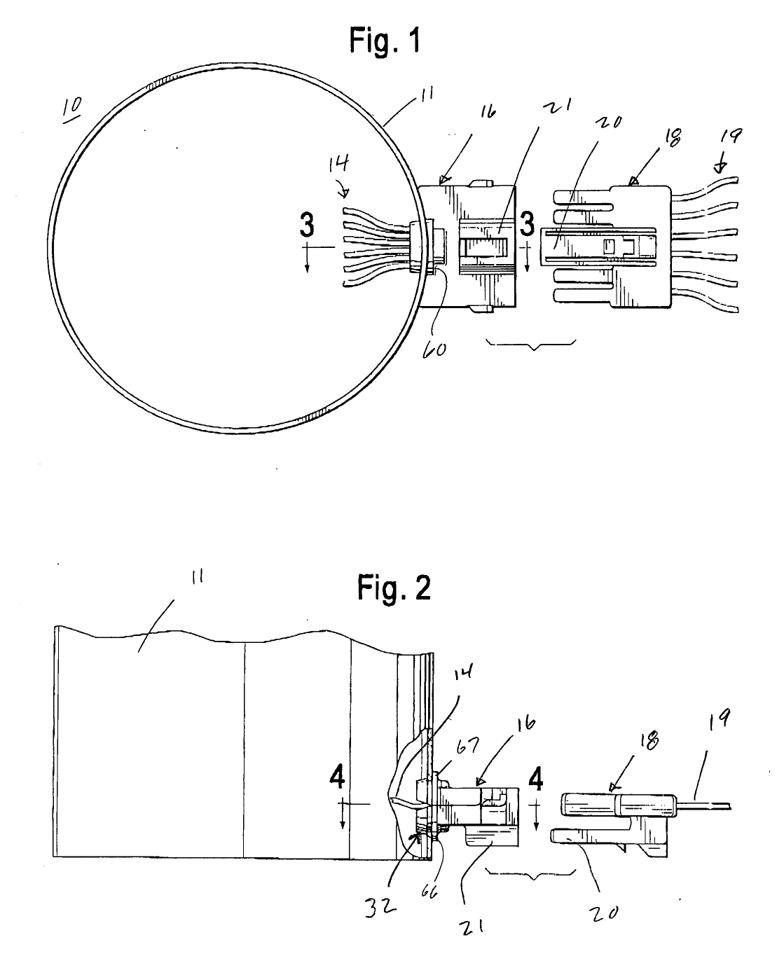

### DETAILED DESCRIPTION OF THE INVENTION

An electrical machine 10, as a motor or generator has a band 11 which encloses the stator and rotor pole structures and associated windings, not shown. Electric leads 14 connect the machine windings with a power source for a motor or with a load for a generator. The leads 14 extend from the interior of band 11 into a power plug housing 16 and are connected with male spade terminals as will be described below. A complementary power receptacle 18 is engageable with plug 16 and has female terminals (not shown) which receive the male terminals and which are connected with conductors 19 through which machine 10 is connected with the power source or load. Releasable latch 20 on receptacle 18 engages a latch receiver 21 on plug 16.

Power plug housing 16, comprises a base member 25, FIG. 6, and a complementary cover member 26, FIG. 5, which form a housing that encloses the machine leads and terminals. Base member 25 is generally rectangular with an inner end wall 28 which is curved to mate with the outer surface of cylindrical machine band 11. Similarly, cover member 26 is generally rectangular with an inner end wall 29 curved to mate with machine band 11.

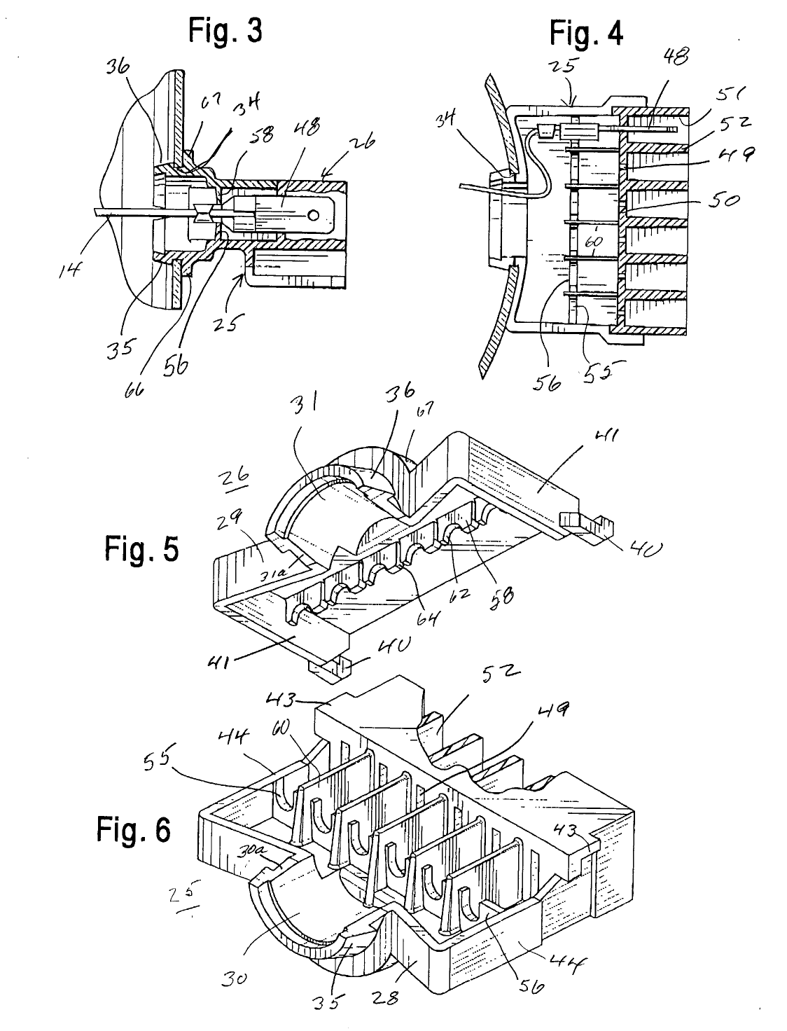

Both base and cover members 25, 26 have a semi-cylindrical neck element, 30, 31, respectively, extending from the center of the curved inner end walls 28, 29. With the base and cover closed, the semi-cylindrical neck elements 30, 31 form a cylindrical fastener or neck 32 for insertion in a hole 34, see FIGS. 3 and 4, in the machine band 11. Tapered ridges 35, 36 on neck elements 30, 31 engage the inner surface of machine band 11 holding the plug members secured to the band. The surface of the ridges 35, 36 facing end walls 28, 29 are curved to mate with the inner surface of band 11.

The material of which the base and cover members 25 and 26 are fabricated is resilient so that the neck elements 30, 31 flex on insertion into hole 32 and recover to hold the housing in place. Mating edges 30a, 31a of the semi-cylindrical neck elements are tapered to allow flexure. A 10° taper on the edges of the neck elements provides 20° separation, see FIG. 2. A suitable material for base and cover members 25, 26 is thermoplastic resin sold by E. I. duPont under the trademark Rynite.

The housing base 25 and cover 26 are hinged together by hooks 40 on the lateral edges 41 of cover 26 which engage mating projections 43 on the lateral edges 44 of base 25.

The electric leads 14 (only one is shown in FIGS. 3 and 4) of the machine extend through the neck 32 of the plug housing 16 and are connected with spade terminals 48 positioned in slots 49 in the outer end wall 50 of the base 25 and which extend into cavities 51 isolated by walls 52. The leads 14 and terminals 48 are received in saddle-like recesses 55 of a transverse rib 56 extending between the lateral walls 44 of the base 25. The leads and terminals are held in the recesses 55 by transverse rib 58 extending between the lateral walls 41 of cover 26.

Divider walls 60 between adjacent terminal receiving recesses 55 isolate the terminals 48 and prevent arcing. Transverse rib 58 has recesses 62 which compliment recesses 55 and hold terminals 48. Slots 64 in rib 58 receive divider walls 60.

In the initial assembly of the machine and power plug the leads 14 are trimmed to length and the terminals 48 attached. The terminals and leads are then placed in the plug housing base 25 in the desired order with the terminals in the slots 53 and seated in the recesses 48. The cover 26 is attached to the base 25 and closed, and the neck 32 inserted through the hole 34 in the machine band 11.

If it should be desirable to change an operating condition of the machine, as the direction of rotation of a motor, this can be accomplished by reversing the position of two of the leads and terminals. The plug housing 16 is pulled from the hole 34 in band 11, the cover 26 opened and the appropriate leads repositioned. The cover 26 is closed and neck 32 of the plug housing 16 is reinserted in hole 34.

Similarly, for example, the leads may be positioned to connect machine windings of a machine in series for operation at a high voltage, as 240 volts, or in parallel for operation at a low voltage, as 120 volts.

Electric machines are often operated in a wet or dirty environment. The neck 32 of plug housing 16 forms a joint with the edge of hole 34 through which water and dirt can enter the machine band and damage the machine. The inner end walls 28, 29 of the base and cover housing members extend across the central portion of the joint, leaving two arcuate joint sections exposed. Arcuate fin segments 66, 67 on the base and cover respectively extend across the exposed joint sections and restrict access of water and dirt.

I claim:

1. A power plug housing for plural electric leads of an electrical machine, comprising:
a base member with a receiver for said leads; and
a cover member with a retainer which holds the leads in the receiver of said base member.

2. The power plug housing of claim 1 in which said base member is generally rectangular and said receiver is a transverse rib with recesses to receive said leads.

3. The power plug housing of claim 2 in which said cover member is generally rectangular and said retainer is a transverse rib which mates with the transverse rib of the base to hold said leads in said recesses.

4. The power plug housing of claim 3 in which the transverse rib of the cover member has recesses which compliment the recesses of the transverse rig of the base member.

5. The power plug housing of claim 1 with divider walls between said leads.

6. The power plug housing of claim 1 including a hinge connecting said cover with said base.

7. The power plug housing of claim 6 in which both members are generally rectangular with lateral edges and the hinge includes hooks on the lateral edges of one member engaged with mating projections on the lateral edges of the other member.

8. A power plug housing for electric leads of an electrical machine having an enclosing band, comprising:
two complementary members engaged to form an enclosure which receives the electric leads of the electrical machine and terminals at the ends of the leads for connection with an electrical network, said members each having an inner end wall for engagement with the band of the machine; and
complementary semi-cylindrical neck elements on the inner end walls of said members, forming a cylindrical neck with the members engaged, said cylindrical neck being insertable into an opening in the machine band, said electric leads extending through said cylindrical neck into the plug housing.

9. The power plug housing of claim 8 including a retaining ridge on the outside of each said neck elements which engages the machine band to secure the connector housing thereto.

10. The power plug housing of claim 9 in which said neck elements have spaced apart facing edges which allow the neck elements to deflect on insertion into or removal from the hole in the machine band.

11. The power plug housing of claim 10 in which said facing edges of the neck elements are spaced apart by an angle of the order of 20°.

12. A power plug housing for electric leads of an electrical machine, comprising:
an enclosure for said leads;
a fastener on said enclosure insertable into an opening in a band of the machine to secure the enclosure to the band, the fastener forming a joint with the band; and
a fin on the enclosure extending across said joint.

13. The power plug housing of claim 12 in which said housing has an inner end wall which extends across a portion of said opening, leaving two exposed joint sections, and said fin has two segments each extending across one of the joint sections.

14. The power plug housing of claim 13 for a machine having a circular opening in the band and in which said fastener is a cylindrical neck, said joint sections are arcuate and said fin segments are arcuate.
